(19) United States
(12) Patent Application Publication
(10) Pub. No.: US 2015/0198824 A1
(43) Pub. Date: Jul. 16, 2015

(54) DISPLAY AND MANUFACTURING METHOD THEREOF

(71) Applicant: InnoLux Corporation, Miao-Li County (TW)

(72) Inventors: Jing-Jia YEH, Miao-Li County (TW); Tsu-Hsien KU, Miao-Li County (TW)

(21) Appl. No.: 14/569,920

(22) Filed: Dec. 15, 2014

(30) Foreign Application Priority Data
Jan. 10, 2014 (TW) 103100955

(51) Int. Cl. G02F 1/1333

(52) U.S. Cl. CPC G02F 1/1333

(57) ABSTRACT

The present invention relates to a display, comprising: a first substrate comprising a first surface and a second surface opposite to the first surface; an edge surface adjacent to the first surface and the second surface, and comprising a side face and a first chamfer portion, wherein the first chamfer portion is disposed between the side face and the first surface; and a protective layer disposed on the first chamfer portion, and exposing at least a part of the side face.

### CROSS REFERENCE TO RELATED APPLICATION

This application claims the benefits of the Taiwan Patent Application Serial Number 103100955, filed on Jan. 10, 2014, the subject matter of which is incorporated herein by reference.

### BACKGROUND OF THE INVENTION

1. Field of the Invention

The present invention relates to a display and a manufacturing method thereof, and especially to a display suitable for a touch panel and a manufacturing method thereof.

2. Description of Related Art

Various types of flat-panel displays, such as tablet computers, smart phones, as well as large displays such as LCD TVs, mostly use a transparent plate as the substrate of a display device or a touch component, or as the outermost cover layer, to improve aesthetic appearance of the display and provide adequate protection.

A plate currently used in a flat panel display may be made of a polymer material (such as acrylic resins) or glass, and presently, glass is most commonly employed. However, those plates (such as glass) are rigid and brittle, and could easily lead to fragmentation by an external pressure, which not only results in a reduced throughput and production yield, but also endangers the personal safety of operators and users. When the plate is under pressure, if flaw is present at the boundary of the plate, crack propagation could be easily initiated from the minor flaw to result in a complete break. Particularly, to comply with the current development of the display panel, the plate tends to have a large area or a thin thickness, which increases the possibility of breakage during processing or transportation of the plate.

In addition, One-Glass-Solution (OGS) touch panel is under rapid development, and in order to integrate the cover glasses of the touch component and the display panel into a single glass plate, the substrate needs to be subjected to multiple processing steps, and the glass is easily damaged during the processes to result in flaws, which can reduce the mechanical strength of the glass plate and cause breakage of the product.

Therefore, it is necessary to develop a simple plate and a manufacturing method thereof, wherein a protective layer is applied on a chamfer portion of the plate to form a plate with an improved mechanical strength.

### SUMMARY OF THE INVENTION

An object of the present invention is to provide a display, and especially a display of a touch panel, comprising: a first substrate, wherein the first substrate comprises a first surface, a second surface opposite to the first surface, an edge surface adjacent to the first surface and the second surface and comprising a side face and a first chamfer portion, wherein the first chamfer portion is disposed between the side face and the first surface, and a protective layer disposed on the first chamfer portion and exposing at least a part of the side face; a display medium disposed on the first substrate; and an upper substrate disposed over the display medium, wherein the exposed surface area of the side face is 15 to 100% of the total surface area of the side face.

In an embodiment of the present invention, it is preferable that the upper substrate has features of the above-described first substrate.

In an embodiment of the present invention, the display may further include a second chamfer portion, which is disposed between the side face and the second surface and adjacent to the side face and the second surface, and the second chamfer portion is covered by the protective layer. In addition, an obtuse angle or an arc angle may be formed independently between the first chamfer portion and the side face and the first surface, and between the second chamfer portion and the side face and the second surface, respectively.

In another embodiment of the present invention, the first substrate is a glass plate, and the glass plate may further include a chemically strengthened layer disposed on the first surface or/and the second surface of the substrate. Alternatively, the chemically strengthened layer may be selectively disposed on at least one of the first chamfer portion, the second chamfer portion, and the side face.

Further, in the display of the present invention, a distance between an end of the side face adjacent to the first surface and an extension line extending from the first surface is less than or equal to half a thickness of the first substrate and greater than or equal to 3 μm, and preferably less than or equal to one third of a thickness of the substrate and greater than or equal to 10 μm; a distance between an end of the side face adjacent to the second surface and an extension line extending from the second surface is less than or equal to half a thickness of the first substrate and greater than or equal to 3 μm, and preferably less than or equal to one third of a thickness of the substrate and greater than or equal to 10 μm.

Furthermore, in the display provided by the present invention, the protective layer may be at least one selected from the group consisting of: silicone rubber, a resin material, and a polymer.

In the displays provided by other embodiments of the present invention, the upper substrate is disposed on the display medium and in contact therewith. However, another embodiment of the present invention may further include a second substrate disposed between the display medium and the upper substrate and in contact with the display medium. In this case, the upper substrate is used as the protective cover of the display, and at least one of the second substrate and the upper substrate has features of the above-described first substrate, and it is preferable that the upper substrate has features of the above-described first substrate.

Another object of the present invention is to provide a method for manufacturing a display, comprising: (A) providing a first substrate having a first surface and a second surface; (B) forming a first recess on the first surface, wherein the first recess comprises a first chamfer portion adjacent to the first surface; (C) disposing a protective layer in the first recess to cover the first chamfer portion; and (D) cutting the protective layer and the first substrate at the first recess, to form an edge surface comprising a side face and the first chamfer portion, wherein the first chamfer portion is disposed between the side face and the first surface and adjacent to the side face and the first surface.

In an embodiment of the present invention, in the case that the first substrate is a glass plate, the step (A) may further include: (A1) forming a chemically strengthened layer on the first surface and the second surface of the first substrate. Alternatively, the step (B) may further include: (B1) forming a chemically strengthened layer on the first surface, the second surface and the surface of the first recess. Alternatively, the step (C) may further include: (C1) forming a chemically strengthened layer on the first surface and the second surface of the first substrate. In addition, the step (D) may further include: (D1) forming a chemically strengthened layer on the first surface, the second surface and the side face.

In another embodiment of the present invention, in the case that the first substrate is a glass plate, the step (B) may further comprise: (B1) forming a second recess opposite to the first recess on the second surface, wherein the second recess comprises a second chamfer portion adjacent to the second surface.

When the first substrate is a glass plate, the step (A) may further include: (A1) forming a chemically strengthened layer on the first surface and the second surface of the first substrate. Alternatively, the step (B) may further include: (B2) forming a chemically strengthened layer on the first surface, the second surface, and the surfaces of the first recess and the second recess. Alternatively, the step (C) may further include: (C1) forming a chemically strengthened layer on the first surface and the second surface of the first substrate. In addition, the step (D) may further include: (D1) forming a chemically strengthened layer on the first surface, the second surface and the side face.

In the manufacturing method of the present invention, a distance between an end of the side face adjacent to the first surface and an extension line extending from the first surface is less than or equal to half a thickness of the first substrate and greater than or equal to 3 μm, and preferably less than or equal to one third of a thickness of the first substrate and greater than or equal to 10 μm; a distance between an end of the side face adjacent to the second surface and an extension line extending from the second surface is less than or equal to half a thickness of the first substrate and greater than or equal to 3 μm, and preferably less than or equal to one third of a thickness of the first substrate and greater than or equal to 10 μm.

Furthermore, in the manufacturing method of the present invention, an obtuse angle or an arc angle may be formed between the first chamfer portion and the side face and the first surface, respectively. Also, an obtuse angle or an arc angle may be formed between the second chamfer portion and the side face and the second surface, respectively.

Further, in the manufacturing method of the present invention, the protective layer is at least one selected from the group consisting of: silicone rubber, a resin material, and a polymer.

A further object of the present invention is to provide a substrate comprising: a first surface; a second surface opposite to the first surface; an edge surface adjacent to the first surface and the second surface, and comprising a side face and a first chamfer portion, wherein the first chamfer portion is disposed between the side face and the first surface; and a protective layer disposed on the first chamfer portion, and exposing at least a part of the side face.

### BRIEF DESCRIPTION OF THE DRAWINGS

FIGS. 1 to 2 and FIGS. 5 to 9 show cross-sectional views of the substrate manufacturing method according to Example 1 of the present invention.

FIGS. 3 and 4 show the schematic diagrams of the recess according to a preferred embodiment of the present invention.

FIGS. 10 to 13 show cross-sectional views of the substrate manufacturing method according to Example 2 of the present invention.

FIGS. 14 to 17 show cross-sectional views of the substrate manufacturing method according to Example 3 of the present invention.

FIGS. 18 to 19 show cross-sectional views of the display according to Example 4 of the present invention.

### DETAILED DESCRIPTION OF THE PREFERRED EMBODIMENT

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention, and those skilled in the art will appreciate that various modifications, additions and substitutions are possible.

Since fragmentation of substrates are commonly caused by the generation of flaws at the chamfer portion, in the display of the present invention, a protective layer is disposed on the first chamfer portion and/or second chamfer portion, to avoid the flaws at the first or second chamfer portion that lead to fragmentation, thus enhancing the strength of the display. This method is also advantageous by simple operation.

### Example 1

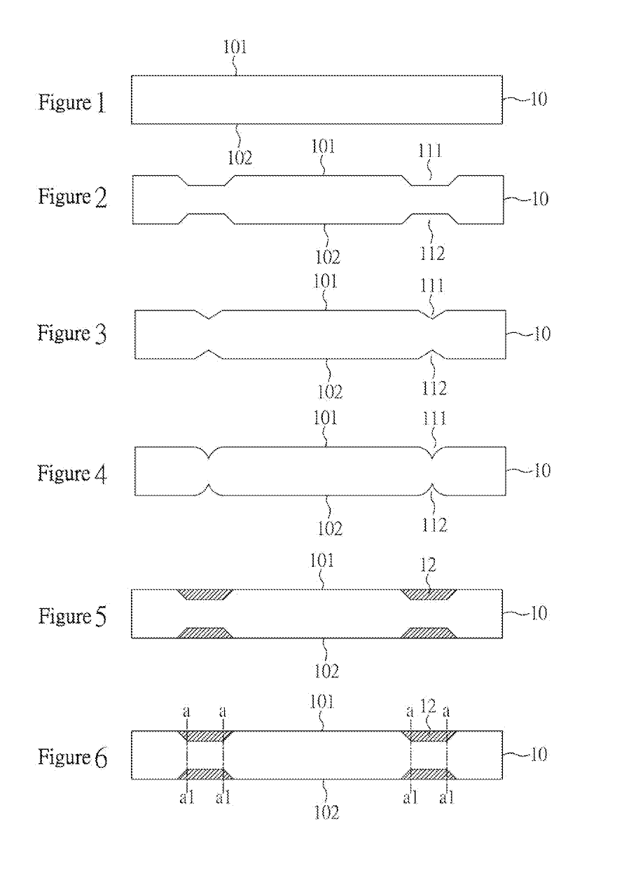

First, a plate 10 as shown in FIG. 1 is provided for the preparation of an one glass solution (OGS) touch panel, which includes a first surface 101 and a second surface 102, while in other embodiments, the plate 10 may be various types of plates made of polymethyl methacrylate (an acrylic resin), a heat-strengthened glass, a chemically strengthened glass, a laminated glass or so on. Then, as shown in FIG. 2, a first recess 111 is formed on the first surface 101 of the plate 10, and a second recess 112 is formed on the second surface 102 of the plate 10. In this Example, the first recess 111 and the second recess 112 are in the shape of symmetric trapezoids, but not particularly limited thereto. FIG. 3 and FIG. 4 are embodiments where the first recess 111 and the second recess 112 are in the shapes of arc or triangle, but the present invention is not limited thereto. Furthermore, in other embodiments, the process can be performed on only one side of the plate, that is, the first recess 111 is formed on the first surface 101 of the plate 10, but no recess is formed on the second surface 102.

Next, referring to FIG. 5, the first recess 111 and the second recess 112 are filled with a protective layer material, which is then cured to form a protective layer 12. In this Example, the protective layer material for forming the protective layer 12 is an epoxy resin. However, in other Examples, the protective layer material for forming the protective layer 12 can be any materials in a liquid or flowable state during the filling process, and become a solid material after curing at −30° C. to 80° C. The protective layer material may have a viscosity within the range of 100 to 200000 Cps. A polymer material, such as silicone rubbers, resins, acrylic and so on, can be used. Preferably, an epoxy resin, a liquid silicone rubber, and an acrylic resin are used as the protective layer material. Furthermore, in other embodiments, the protective layer materials for filling the first recess 111 and the second recess 112 may be the same as or different from each other.

As shown in FIG. 6, at the first recess 111, the protective layer 12 and the plate 10 are cut along the cutting line a-al to form a substrate 20 as shown in FIG. 7. The formed substrate 20 includes a first surface 101, a second surface 102 opposite to the first surface 101, an edge surface 13, and a protective layer 12, wherein the edge surface 13 includes a first chamfer portion 131, a second chamfer portion 132, and a side face 133. The first chamfer portion 131 is disposed between the side face 133 and the first surface 101 and adjacent to the side face 133 and the first surface 101, and the second chamfer portion 132 is disposed between the side face 133 and the second surface 102 and adjacent to the side face 133 and the second surface 102. The protective layer 12 covers the first chamfer portion 131 and the second chamfer portion 132 to provide a protective effect, and at least a part of the side 133 is exposed, wherein the exposed surface area of the side face may be 15 to 100%, and preferably 20 to 100% of the total surface area of the side face. Moreover, as shown in FIG. 7, in the edge surface 13, the shortest distance d between the first chamfer portion 131 and the second chamfer portion 132 may be greater than or equal to one third of the thickness of the substrate 20, that is, a distance d1 between an end 1331 of the side face 133 adjacent to the first surface 101 and an extension line extending from the first surface 101 is less than or equal to one third of a thickness of the substrate 20 and greater than or equal to 10 μm, while a distance d2 between an end 1332 of the side face adjacent to the second surface 102 and an extension line extending from the second surface 102 is less than or equal to one third of a thickness of the substrate 20 and greater than or equal to 10 μm. However, in other embodiments, in the case that the recess is not formed on the second surface 102, the shortest distance between the first chamfer portion 131 and the second surface 102 may be half of the thickness of the substrate 20 or more. That is, a distance d1 between an end 1331 of the side face 133 adjacent to the first surface 101 and an extension line extending from the first surface 101 may be less than or equal to half a thickness of the substrate 20 and greater than or equal to 3 μm, and in other embodiments, a distance d1 between an end 1331 of the side face 133 adjacent to the first surface 101 and an extension line extending from the first surface 101 may be less than or equal to one third of a thickness of the substrate 20 and greater than or equal to 10 μm. Furthermore, in other embodiments, when the first recess 111 and a second recess 112 have other shapes, they may be cut along the deepest portion of the recess to form a plate with a chamfer portion.

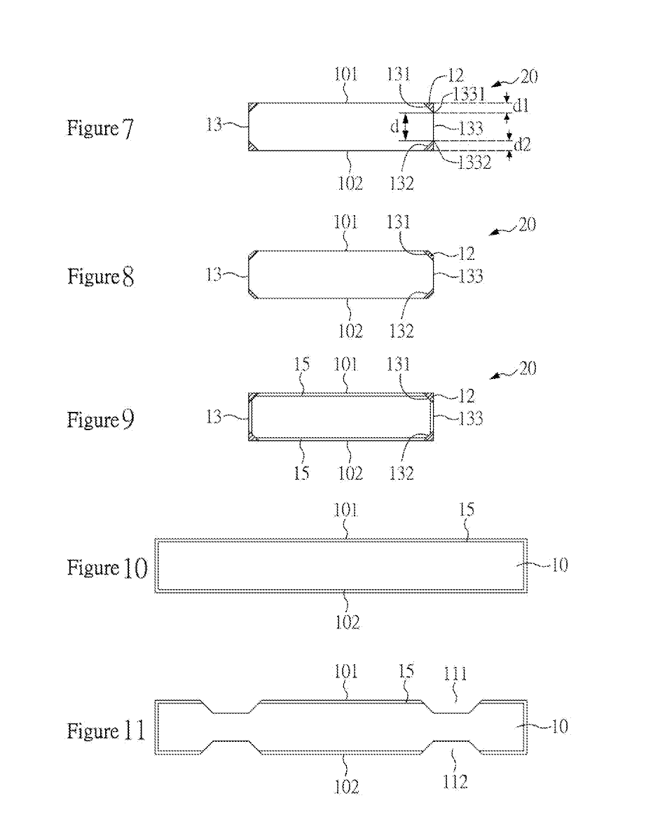

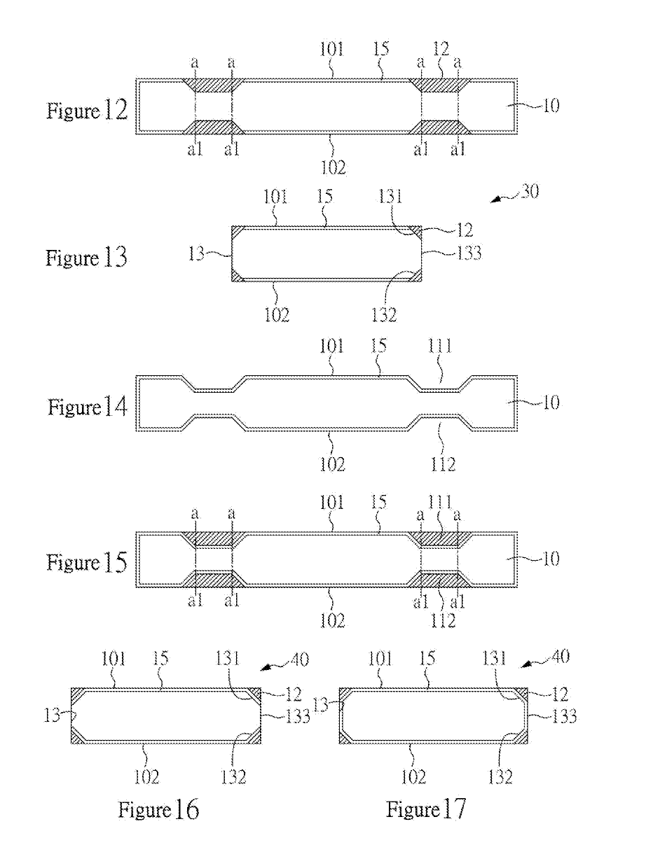

Alternatively, the substrate 20 as shown in FIG. 7 may be further modified. For example, as shown in FIG. 8, the apex 12 of the protective layer may be planarized to avoid damage to the protective layer 12. Further, when the substrate 20 of the present Example is a glass plate, in order to increase the mechanical strength of the substrate 20, the surface of the substrate 20 of FIG. 7 is chemically strengthened to form the chemically strengthened layer 15 as shown in FIG. 9. In this Example, the chemically strengthened layer 15 is formed by immersing the substrate 20 made of glass into a solution containing potassium ions to allow ion exchange between the sodium ions in the glass surface and the potassium ions in the solution, to thereby form the chemically strengthened layer 15 on the exposed surface (the first surface 101, the second surface 102, the side face 133) of the glass substrate.

### Example 2

The preparation procedure and materials used in this Example are substantially the same as in Example 1, and therefore the descriptions in Example 1 are also applicable to the counterparts herein, and the same description will not be repeated.

First, a plate 10 as shown in FIG. 10 is provided, and in this Example, the plate 10 is a glass substrate. Then, the plate 10 is immersed in a solution containing potassium ions to allow ion exchange between the sodium ions in the surface of the plate 10 and the potassium ions in the solution to form the chemically strengthened layer 15. As shown in FIG. 11, the first recess 111 is formed on the first surface 101 of the plate 10, and the second recess 112 is formed on the second surface 102 of the plate 10. Then, the first and second recesses 111, 112 are filled with the protective layer material, which are then cured to form the protective layer 12. After forming the protective layer 12, the protective layer 12 and the plate 10 are cut along the cutting line a-al as shown in FIG. 11 to form a substrate 30 as shown in FIG. 13. The formed substrate 30 includes a first surface 101, a second surface 102 opposite to the first surface 101, a chemically strengthened layer 15 on the first surface 101 and second surface 102, an edge surface 13 adjacent to the first surface 101 and second surface 102, and a protective layer 12. The edge surface 13 includes a first chamfer portion 131, a second chamfer portion 132, and a side face 133. The first chamfer portion 131 is disposed between the side face 133 and the first surface 101 and adjacent to the side face 133 and the first surface 101, while the second chamfer portion 132 is disposed between the side face 133 and the second surface 102 and adjacent to the side face 133 and the second surface 102. In this Example, the chemically strengthened layer 15 is formed on the first surface 101 and the second surface 102 of the plate 10, while the chemically strengthened layer 15 is not formed on the side face 133, the first and second chamfer portions 131, 132.

### Example 3

The preparation procedure and materials used in this Example are substantially the same as in Example 1, and therefore the descriptions in Example 1 are also applicable to the counterparts herein, and the same description will not be repeated.

First, as shown in FIG. 14, a plate 10 is provided in which a first recess 111 is formed on the first surface 101 and a second recess 112 is formed on the second surface 102. In this Example, the plate 10 is a glass plate. Then, the plate 10 is immersed in a solution containing potassium ions to allow ion exchange between the sodium ions in the surface of the plate 10 and the potassium ions in the solution to form the chemically strengthened layer 15 on the surface of the plate. As shown in FIG. 14, the chemically strengthened layer 15 is formed on the first surface 101 and the second surface 102 of the plate 10, and the surfaces of the first recess 111 and the second recess 112. Then, the first and second recesses 111, 112 are filled with the protective layer material, which are then cured to form the protective layer 12. The protective layer 12, the chemically strengthened layer 15 and the plate 10 are cut along the cutting line a-al as shown in FIG. 15 to form a substrate 40 as shown in FIG. 16. The formed substrate 40 includes a first surface 101, a second surface 102 opposite to the first surface 101, an edge surface adjacent to the first surface 101 and second surface 102, a chemically strengthened layer 15, and a protective layer 12. wherein the edge surface 13 includes a first chamfer portion 131, a second chamfer portion 132, and a side face 133, and the first chamfer portion 131 is disposed between the side face 133 and the first surface 101 and adjacent to the side face 133 and the first surface 101, while the second chamfer portion 132 is disposed between the side face 133 and the second surface 102 and adjacent to the side face 133 and the second surface 102. In this Example, the chemically strengthened layer 15 is formed on the first surface 101, the second surface 102, the first chamfer portion 131, and the second chamfer portion 132, while the chemically strengthened layer 15 is not formed on the surface of the side face 133. However, in other embodiments, in order to increase the mechanical strength of the surface of the edge surface 13, the plate as shown in FIG. 16 may be immersed in the solution containing potassium ions again, such that the chemically strengthened layer 15 is also formed on the surface of the side face 133 of the plate as shown in FIG. 17.

According to the display and the manufacturing method of the present invention, the skilled person in the art may adjust the shape or depth of the recess to form a chamfer portion having a different shape according to the purpose of use or the desired mechanical strength of the substrate. Also, when the substrate is a glass substrate, the position where the chemically strengthened layer is formed can be determined based on the procedure used.

### Example 4

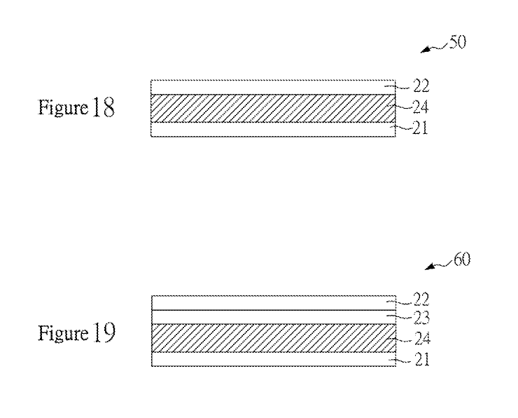

This Example provides a display. FIG. 18 is a cross-sectional view of a display panel 50 in the display. The display panel 50 includes a first substrate 21, an upper substrate 22, and a display medium 24 disposed on the first substrate 21 and the upper substrate 22. In this Example, the upper substrate 22 is the plate prepared in anyone of Examples 1 to 3, but in other embodiments, the first substrate 21 may also be the plate prepared in anyone of Examples 1 to 3. Further, FIG. 19 shows the display according to another embodiment of the present invention, and the display 60 as shown in FIG. 19 may further include a second substrate 23 disposed between the upper substrate 22 and the display medium 24, wherein the upper substrate 22 is served as a protective cover. In other embodiments, at least one of the first substrate 21, the second substrate 23 and the upper substrate 22 may be the plate prepared in anyone of Examples 1 to 3, or only the upper substrate 22 as the protective cover is the substrate prepared in anyone of Examples 1 to 3.

Besides, the display 50, 60 of this Example is a liquid crystal display, and the display medium 24 is a liquid crystal molecule. However, in other embodiments, the display medium may be an organic light emitting element, and the display 50, 60 may be an organic light emitting display. Alternatively, in other embodiments, the display 50, 60 may be other types of displays which are known in the art with a corresponding display medium 24. In addition to displays, the substrates prepared in Examples 1 to 3 can also be used in a touch device.

Although the present invention has been explained in relation to its preferred embodiment, it is to be understood that many other possible modifications and variations can be made without departing from the spirit and scope of the invention as hereinafter claimed.

What is claimed is:

1. A display, comprising:
a first substrate, wherein the first substrate comprises a first surface and a second surface opposite to the first surface; an edge surface adjacent to the first surface and the second surface, and comprising a side face and a first chamfer portion, wherein the first chamfer portion is disposed between the side face and the first surface; and a protective layer disposed on the first chamfer portion, and exposing at least a part of the side face;
a display medium disposed on the first substrate; and
an upper substrate disposed over the display medium.

2. The display of claim 1, further comprising a second chamfer portion disposed between the side face and the second surface and covered by the protective layer.

3. The display of claim 1, wherein the first substrate is a glass plate.

4. The display of claim 3, wherein the glass plate further comprises a chemically strengthened layer disposed on the first surface and the second surface of the first substrate.

5. The display of claim 4, wherein the chemically strengthened layer is further disposed on at least one of the first chamfer portion, the second chamfer portion, and the side face.

6. The display of claim 1, wherein a distance between an end of the side face adjacent to the first surface and an extension line extending from the first surface is less than or equal to half a thickness of the first substrate, and greater than or equal to 3 μm.

7. The display of claim 1, wherein the protective layer is at least one selected from the group consisting of: silicone rubber, a resin material, and a polymer.

8. A method for manufacturing a display, comprising:
(A) providing a first substrate having a first surface and a second surface;
(B) forming a first recess on the first surface, wherein the first recess comprises a first chamfer portion adjacent to the first surface;
(C) disposing a protective layer in the first recess to cover the first chamfer portion; and
(D) cutting the protective layer and the first substrate at the first recess, to form an edge surface comprising a side face and the first chamfer portion, wherein the first chamfer portion is disposed between the side face and the first surface.

9. The method of claim 8, in step (B), further comprising: (B1) forming a second recess opposite to the first recess on the second surface, wherein the second recess comprises a second chamfer portion adjacent to the second surface.

10. A substrate comprising:
a first surface;
a second surface opposite to the first surface;
an edge surface adjacent to the first surface and the second surface, and comprising a side face and a first chamfer portion, wherein the first chamfer portion is disposed between the side face and the first surface; and
a protective layer disposed on the first chamfer portion, and exposing at least a part of the side face.
